(19) United States
(12) Patent Application Publication
(10) Pub. No.: US 2015/0170551 A1
(43) Pub. Date: Jun. 18, 2015

(54) Identification Method and Tag for Painted Substrates

(71) Applicant: Infosight Corporation, Chillicothe, OH (US)

(72) Inventors: Edward S. O'Neal, Rockbridge, OH (US); G. David Hudelson, Pickerington, OH (US)

(73) Assignee: INFOSIGHT CORPORATION, Chillicothe, OH (US)

(21) Appl. No.: 14/558,846

(22) Filed: Dec. 3, 2014

Related U.S. Application Data
(60) Provisional application No. 61/917,520, filed on Dec. 18, 2013.

(51) Int. Cl. G09F 3/02; B32B 38/00; B32B 37/12; G09F 3/00; B32B 37/18

(52) U.S. Cl. CPC G09F 3/02; G09F 3/0297; B32B 37/18; B32B 37/1292; B32B 38/145; G09F 2003/0202; G09F 2003/0208; G09F 2003/0257; B32B 2519/00

(57) ABSTRACT

A product identifying tag has a front surface and a back surface. Multiple readable product identification indicia are printed on one or more of the tag front surface or the tag back surface. A transparent overlay covers each of the multiple readable product tag product identification indicia. Each overlay is separately removable from each of the multiple readable product tag product identification indicia. Alternatively, there may be only one set of product identifying indicia and a first adhesively coated transparent overlay covers the product identification indicia while a second adhesively coated transparent film overlays the first adhesively coated transparent overlay.

### CROSS-REFERENCE TO RELATED APPLICATIONS

This application claims benefit of U.S. Provisional Application 61/917,520 filed on Dec. 18, 2013.

### STATEMENT REGARDING FEDERALLY SPONSORED RESEARCH

Not applicable.

### BACKGROUND

The present invention relates generally to the need to identify (track) individual pieces (e.g., ferrous metals, such as, for example, steel) during painting or similar operations and more particularly to a method and novel identification tag therefor.

In the manufacture of steel beams (by way of illustration and not limitation), the beam is fabricated according to a mechanical drawing having a drawing number and sent to a contractor or an installer. Often, the beam gets painted—sometimes, more than once. The steel beam may be devoid of any identification marks, other than possibly a dot peen marking or coded “punch” marks. The paint coating can obscure such physical marks.

Traditional adhesive backed paper or polyester labels cannot be used for identification, because they would prevent a portion of the beam from being properly painted and/or would be covered by paint additionally, which would obscure any identifying indicia on the label. It is the ability to provide product identification (tracking) for painted parts to which the present disclosure is addressed.

### BRIEF SUMMARY

A product identifying tag has a front surface and a back surface. Multiple readable product identification indicia are printed on one or more of the tag front surface or the tag back surface. A transparent overlay covers each of the multiple readable product tag product identification indicia. Each overlay is separately removable from each of the multiple readable product tag product identification indicia. For present purposes, “multiple” means two or more.

The tag having a front surface and a back surface can have readable product identification indicia printed on the tag. A first adhesively coated transparent overlay covers the product identification indicia. A second adhesively coated transparent overlay covers at least a portion of the first adhesively coated transparent overlay.

With multiple product identifying indica printed on the tag, such indicia may be the same or different. So too, more than two transparent overlays can be used on top of each other to increase the number of times the part, and thus the tag, are coated or painted and still reveal the readable product identifying indicia.

### BRIEF DESCRIPTION OF THE DRAWINGS

For a fuller understanding of the nature and advantages of the present invention, reference should be had to the following detailed description taken in connection with the accompanying drawings, in which:

FIG. 1 is an isometric view of an I-beam with attached identification tag being painted, for example, orange;

FIG. 2 is a front view of a disclosed tag having product identifying indicia thereon and having a perforated removable transparent overlay;

FIG. 3 is the tag of FIG. 2 with the transparent overlay being applied to the front face of the tag to overlay the product identifying indica printed on the front face of the tag;

FIG. 4 is the tag of FIG. 2 wherein the transparent overlay has been painted to obscure the product identifying indicia and where the bottom section of the overlay is being removed at the perforation to again reveal the product identifying indicia;

FIG. 5 is a roll of perforated transparent plastic from which the overlay in FIG. 2 has been cut;

FIG. 6 is a blank (e.g., metal, plastic, cellulosic, ceramic, etc.) having an opaque overlay containing product identifying indicia affixed with a higher tack adhesive to the blank and having an outer lower tack transparent overlay;

FIG. 7 shows the structure of FIG. 6 being assembled;

FIG. 8 is the structure of FIG. 6 wherein the transparent has been painted to obscure the product identifying indicia and wherein the painted transparent overlay is being peeled off to reveal the product identifying indicia;

FIG. 9 is a blank (e.g., metal, plastic, cellulosic, ceramic, etc.) having an opaque overlay containing product identifying indicia affixed with a higher tack adhesive to the blank and having an outer lower tack transparent overlay;

FIG. 10 shows the structure of FIG. 9 being assembled;

FIG. 11 is the structure of FIG. 9 wherein the perforated transparent overlay has been painted to obscure the product identifying indicia and wherein a section of the painted perforated transparent overlay is being peeled off to reveal the product identifying indicia;

FIG. 12 is a blank (e.g., metal, plastic, cellulosic, ceramic, etc.) having an opaque overlay containing product identifying indicia affixed with a higher tack adhesive to the blank and having two outer transparent overlays with the outer transparent overlay having a lower tack adhesive on its back than the inner transparent overlay;

FIG. 13 shows the structure of FIG. 12 being assembled;

FIG. 14 is the structure of FIG. 12 wherein the outer transparent overlay has been painted to obscure the product identifying indicia and wherein the painted outer transparent overlay is being peeled off to reveal the product identifying indicia and wherein a corner of the inner transparent layer is seen being pulled off too;

FIG. 15 is a blank (e.g., metal, plastic, cellulosic, ceramic, etc.) having a perforated opaque overlay containing duplicate sets of product identifying indicia affixed with a higher tack adhesive to the blank and having an outer lower tack perforated transparent overlay;

FIG. 16 shows the structure of FIG. 15 being assembled;

FIG. 17 is the structure of FIG. 15 wherein the perforated transparent overlay has been painted to obscure the product identifying indicia and wherein a section of the painted perforated transparent overlay is being peeled off to reveal the product identifying indicia and one of the product identifying opaque overlays is being peeled off too, such as for recording purposes;

FIG. 18 is an isometric view of a tag having product identifying indicia on both sides and having an adhesively coated transparent overlay being applied to both faces of the tag;

FIG. 19 is back face view of a transparent overlay having the top section coated with a higher tack adhesive than is the bottom section;

FIG. 20 is a back face view of a transparent overlay coated with an adhesive layer;

FIG. 21 is a back view of a transparent overlay having only the side edges coated with an adhesive layer; and

FIG. 22 is a back view of a transparent overlay coated with an adhesive layer wherein the side edges devoid of adhesive.

The drawings will be described in detail below.

### DETAILED DESCRIPTION

A few definitions are appropriate for the present disclosure:
By “readable” is meant that the identification indicia can be read by the intended method, i.e., human readable and/or machine-readable.
By “identification indicia” or “product identification indicia” is meant information about the part including, for example, manufacturing date, drawing number, part number, manufacturing location, manufacturer, site assembly location, license plate (piece) identification, etc.

As is illustrated in FIG. 1, an identification tag, 14, is affixed to an I-beam, 10, to provide its identification indicia. I-beam 10, however, has been painted orange for decorative and/or protection purposes. Such orange paint, however, has coated most of the surface of identification tag 14, thus, obscuring its product identification indicia. It becomes necessary, then to re-establish the identification indicia. The present disclosure addresses this need.

Referring initially to FIG. 1, an I-Beam, 10, is being painted by a paint gun, 12, the particular color being irrelevant for present purposes. I-beam 10 has a product identifying tag, 14, affixed that additionally is painted, resulting in the product identifying indicia being obscured. In fact, I-beam 10 may be painted or coated more than once, including the same and/or a different color. It should be understood that an I-beam also is used for illustrative purposes, as a wide variety of metal parts, pre-fabricated, partially fabricated, and fully fabricated, require that product identification indicia be associated with the part as it proceeds from manufacturing to final installation.

It is typical for at least the front surface of tag 14 to contain duplicate product identification indicia, typically located on an upper portion and on a lower portion on tag 14 about its horizontal center line/axis. Such product identification indicia typically will be both machine readable and human readable. Use of a bar code, such as a picket fence bar code, often is encountered; although, use of a QR or similar code also can be used. Such product identification indicia or different information also may appear on the back surface of the tag. On occasion, different product information is needed, such as, for example, one set of indicia indicative of the product number, date of manufacture, and similar information. The second set of indicia may the customer name and shipping address.

In order to re-establish the product identification indicia on tag 14 when such product identification indicia has become obscured, such as, for example, by part painting that also covers the product identification indicia, a transparent film is applied to at least the front surface of the tag product identification indicia-containing tag. Such transparent film may be split. By “split” film is meant that at least 2 separable layers of transparent film cover the product identification indicia so that the product identification indicia can be revealed at least twice by separate removal of each transparent film.

Such split transparent films for tags containing duplicate product identification indicia on a front surface of the tag include, for example:
(a) a lower transparent film layer covering the entire front surface and an upper transparent film layer covering only one of the sets of product identification indicia on the tag;
(b) a lower transparent film layer covering the entire front surface and an upper transparent film layer covering only one of the product identification indicia and extending beyond the tag for aiding in its removal;
(c) a lower transparent film layer covering the entire front surface and separate upper transparent film layers, each covering one of the product identification indicia; and
(d) a lower transparent film layer covering the entire front surface and separate upper transparent film layers covering both of the product identification indicia with one or both of the upper transparent film layers extending beyond the tag for aiding it its removal.

Other configurations can be envisioned for such transparent film layers. Important is that the product identification indicia can be re-established or revealed after it has been obscured by, for example, paint covering the product identification indicia by separate removal of the two or more transparent films covering the tag product identification indicia.

The layer(s) of transparent film(s) will carry an adhesive layer (continuous or discontinuous) for adhering the transparent film to the tag or to an underneath transparent film. The adhesive should be sufficiently tacky so that the transparent film is retained; yet, not so tacky as to prevent removal of the transparent film to reveal obscured product identification indicia.

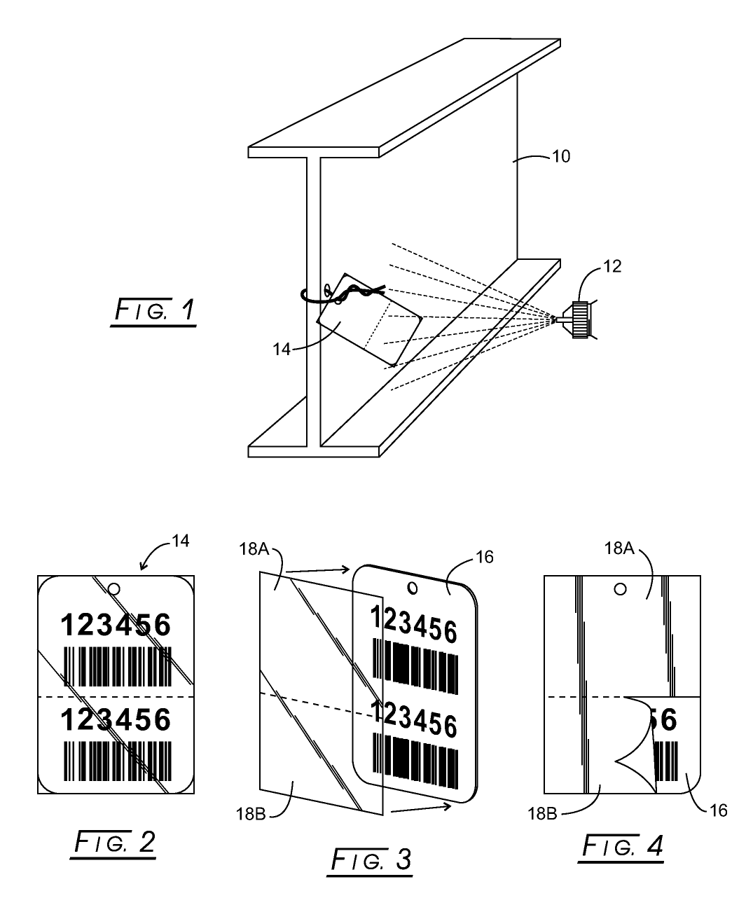

Referring now to FIGS. 2-4, a tag, 16, has duplicate product identifying indicia formed on its front, most often by printing. Such product identifying indicia includes both machine readable indicia and human readable indicia, as illustrated in the drawings. Two different sets of product identifying indicia also could be displayed on tag 16. A perforated transparant overlay formed from a pair of sections, 18A and 18B, overlays the front of tag 16 and covers the product identifying indicia. A horizontal perforation is seen in FIGS. 2-4; however, such perforation also can be diagonal, vertical, or other orientation. The overlayed tag in FIG. 4 has been painted so as to obscure the part identifying indicia. Lower overlay section 18B is seen being peeled off to reveal one of the sets of product identifying indicia on the front face of tag 16. This configuration permits the product to be painted a second time with removal of overlay section 18A revealing the product identifying indicia again. Multiple perforated sections and/or additional overlays would permit additional part painting with overlay and/or overlay section removal reestablishing readability of the product identifying indicia.

Often, the overlays are supplied as a roll of overlays. FIG. 5 shows a roll of overlay material, 20, having a longitudinal perforation, 22. Individual tag overlays can be made by cutting the roll material at an appropriate length. Application of the adhesive layer to the back of the transparent overlay can be accomplished using known applicators, such as, for example, as is illustrated in U.S. Pat. No. 6,764,016. The transparent overlay films can be coated with, for example, acrylic, vinyl, and synthetic rubber adhesives. Suitable overlay materials include, for example, acetate films, acrylic films, vinyl films, polyethylene films, polypropylene films, and the like.

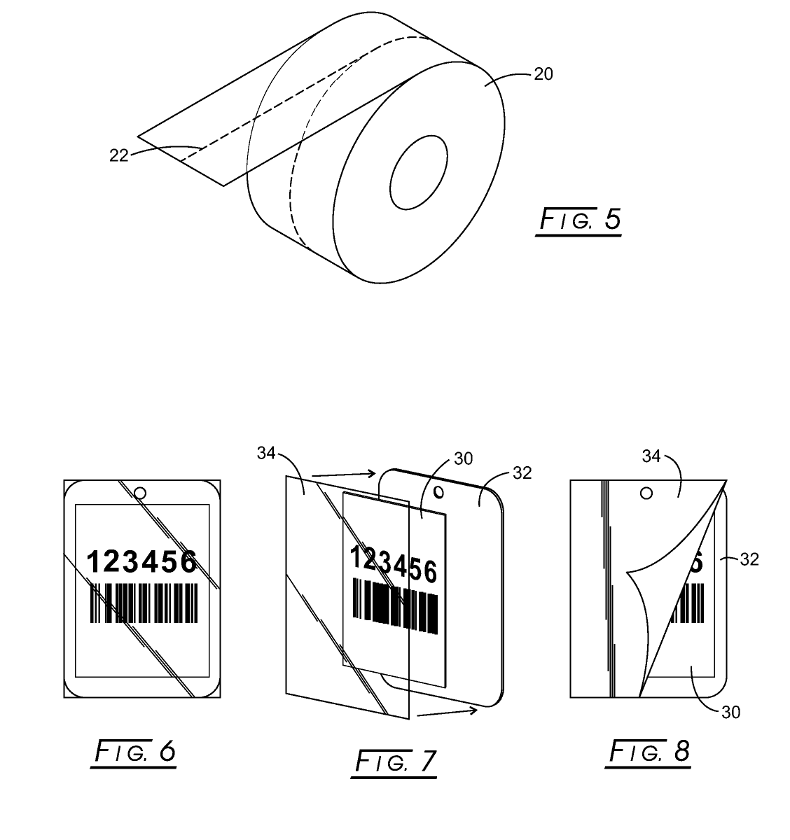

Referring now to FIGS. 6-8, an adhesively coated tag (e.g., paper, plastic, etc.) containing product identifying indicia, 30, is affixed to a blank, 32, which most often is formed from metal for durability; although, other materials as listed herein may be used. The adhesive on the back of tag 30 has a high tack as its removal is not desired. A transparent overlay, 34 having a lower tack adhesive on its back is applied to the entire front surface of blank 32 so as to cover tag 30 also. It probably is worth mentioning at this point that the adhesive used to coat the back sides of the transparent overlays is sufficiently transparent as well so that the product identifying indicia can be suitably read. In FIG. 8, transparant overlay 34 has been painted. Peeling back painted transparent overlay 34 reveals the product identifying indicia again.

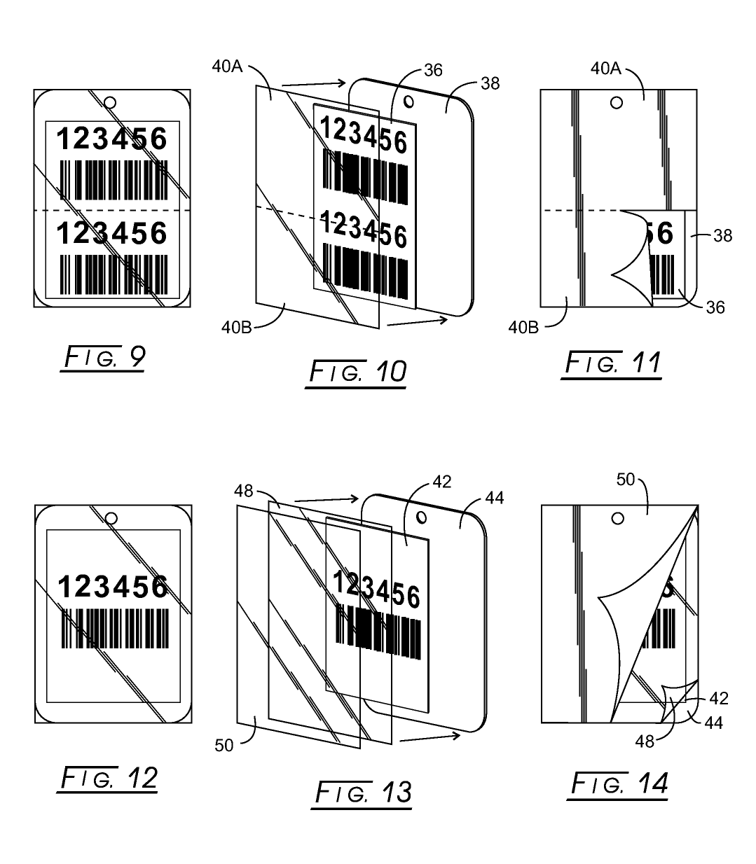

Referring now to FIGS. 9-11, an adhesively coated tag containing product identifying indicia, 36, is affixed to a blank, 38, which most often is formed from metal for durability; although, other materials as listed herein may be used. The adhesive on the back of tag 36 has a high tack as its removal is not desired. A transparent overlay having an upper section, 40A, and a lower section, 40B, having a lower tack adhesive on the backs of both sections is applied to the entire front surface of blank 38 so as to cover tag 36 also. In FIG. 11, transparant overlay 40 has been painted. Peeling back painted transparent overlay section 40B reveals the product identifying indicia again.

Referring now to FIGS. 12-14, an adhesively coated product identifying indicia tag, 42, is affixed to a blank, 44, which most often is formed from metal for durability; although, other materials as listed herein may be used. The adhesive on the back of tag 42 has a high tack as its removal is not desired. An inner transparent overlay, 48, is applied to blank 44 so as to cover tag 42 also. An outer transparent overlay, 50, is applied over inner transparent overlay 48. As seen in FIG. 14, outer overlay 50 has been painted, thus obscuring the product identifying indicia on tag 42. Outer overlay 50 can be peeled off to reveal the product identifying indicia again. Using two transparent overlays permits the part to be painted a second time with removal of inner transparent overlay 48 revealing the product identifying indicia again. Each overlay may be made from a different material for different purposes.

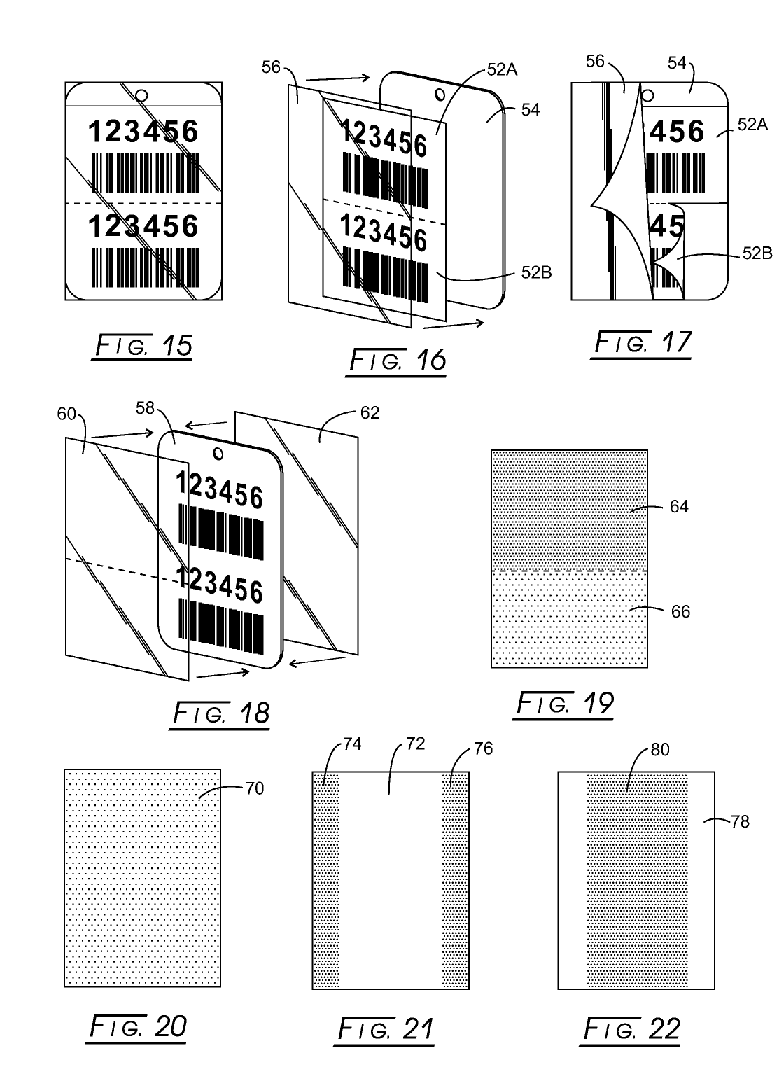

Referring now to FIGS. 15-17, an adhesively perforated coated tag, 52, is formed from an upper tag section, 52A, and a lower tag section, 52B. Both tag sections have product identifying indicia imprinted thereon. Tag 52 is affixed to a blank, 54, which most often is formed from metal for durability; although, other materials as listed herein may be used. A transparent overlay, 56, is applied to the entire front surface of blank 54 so as to cover tag 52 also. In FIG. 17, transparant overlay 56 has been painted along with the part to which it is affixed. Peeling back painted transparent overlay 56 reveals product identifying indicia, 52, again. Thereafter, tag section 52B can be removed, for example, for record purposes.

Referring to FIG. 18, a tag, 58, has product identifying indicia imprinted on both its front face and on its back or rear face (not seen in the drawings). A transparent overlay, 60, is applied over the front face of tag 58, while a transparent overlay, 62, is applied over the rear face of tag 58. This embodiment permits the part to which this tag structure to be painted twice; yet, still have the capability of revealing the product identifying indicia again by separate removal of transparent overlays 60 and 62. It will be observed that no perforations are needed for the transparent overlays. With perforated transparent overlays on both the front and rear surfaces of tag 58, the part to which this tag structure is affixed could be painted up to 4 times.

Referring now to FIGS. 19-22, transparent overlays are illustrated with different patterns of different tack adhesives applied to one of the faces thereof. In FIG. 19, the overlay has an upper section, 64, having a higher tack adhesive than does lower section 66. Of course, sections 64 and 66 are separated by a perforation line. In FIG. 20, a single tack adhesive is applied to one of the surfaces of overlay 70. In FIG. 21, a transparent overlay, 72, has one side edge, 74, coated with an adhesive and the opposite side edge, 76, coated with an adhesive, leaving the mid-section uncoated. Such adhesive edges may be coated with the same or different tack adhesive. In FIG. 22, a tag, 78, has its mid section, 80, coated with an adhesive, leaving the side edges uncoated with adhesive.

It will be apparent that a variety of combinations and permutations of these various selective adhesive areas are possible, along with the use of multiple transparent overlays along with multiple product identifying indicia on one or both sides of a tag. All of such combinations and permutations are encompassed with the spirit and scope of this disclosure.

While the device and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all amounts and percentages are by weight, unless otherwise expressly indicated. Also, all citations referred herein are expressly incorporated herein by reference.

We claim:

1. A product identifying tag, which comprises:
(a) a tag having a front surface and a back surface;
(b) multiple readable product identification indicia being printed on one or more of the tag front surface or the tag back surface; and
(c) a transparent overlay covering each of the multiple readable product identification indicia, each overlay being separately removable from each of the multiple readable product identification indicia.

2. The product identifying tag of claim 1, wherein said tag is applied to a metal blank.

3. The product identifying tag of claim 1, wherein said transparent overlay comprises one or more of an acetate film, an acrylic film, a vinyl film, a polyethylene film, or a polypropylene film.

4. The product identifying tag of claim 1, wherein either:
(a) said transparent overlay has at least two sections, each section being separated by a perforation and each overlay section being separately removable, the multiple readable product identification indicia being printed on the tag front surface or on the tag back surface; or
(b) the duplicate readable product identification indicia being printed on both the tag front surface and on the tag back surface, a transparent overlay covering each of the multiple readable product identification indicia.

5. The product identifying tag of claim 1, wherein said overlay is supplied from a roll.

6. The product identifying tag of claim 1, wherein an adhesive is applied to select areas of the transparent overlay or adhesives of different tack are applied to select areas of the transparent overlay.

7. The product identifying tag of claim 1, wherein said overlay is perforated.

8. A product identifying tag, which comprises:
(a) a tag having a front surface and a back surface;
(b) readable product identification indicia printed on the tag;
(c) a first adhesively coated transparent overlay covering the product identification indicia; and
(d) a second adhesively coated transparent overlay covering at least a portion of the first adhesively coated transparent overlay.

9. The product identifying tag of claim 8, wherein said tag is applied to a metal blank.

10. The product identifying tag of claim 8, wherein said transparent overlays independently are one or more of an acetate film, an acrylic film, a vinyl film, a polyethylene film, or a polypropylene film.

11. The product identifying tag of claim 8, wherein multiple readable product identification indicia are printed on the tag front surface, the tag back surface, or both tag surface.

12. The product identifying tag of claim 11, wherein either or both of the overlays are perforated.

13. The product identifying tag of claim 8, wherein the transparent overlays have adhesives of different tack applied to select areas of the overlays.

14. A method for identifying parts, which comprises the steps of:
(a) supplying a tag having a front surface and a back surface;
(b) printing multiple readable product identification indicia on one or more of the tag front surface or the tag back surface; and
(c) applying a transparent overlay covering each of the multiple readable product identification indicia, each overlay being separately removable from each of the multiple readable product identification indicia.

15. The method of claim 14, wherein said transparent overlay comprises one or more of an acetate film, an acrylic film, a vinyl film, a polyethylene film, or a polypropylene film.

16. The method of claim 14, wherein the overlay is supplied from a roll.

17. The method of claim 14, wherein an adhesive is applied to select areas of the transparent overlay or adhesives of different tack are applied to select areas of the transparent overlay.

18. The method of claim 14, wherein the overlay is perforated.

19. A method for identifying parts, which comprises the steps of
(a) supplying a tag having a front surface and a back surface;
(b) printing readable product identification indicia on the tag;
(c) applying a first transparent overlay covering the readable product tag product identification indicia; and
(d) applying a second transparent overlay covering the first transparent overlay.

20. The method of claim 19, wherein said transparent overlays comprise one or more of an acetate film, an acrylic film, a vinyl film, a polyethylene film, or a polypropylene film.

21. The method of claim 19, wherein at least one of the overlays is supplied from a roll.

22. The method of claim 19, wherein an adhesive is applied to select areas of at least one of said transparent overlays or adhesives of different tack are applied to select areas of at least one of said transparent overlays.

23. The method of claim 19, wherein at least one the overlays is perforated.

24. The method of claim 19, wherein multiple product identifying indicia is printed on the tag front surface, the tag rear surface, or both of said tag surfaces.
